(19) United States
(12) Patent Application Publication
(10) Pub. No.: US 2011/0207405 A1
(43) Pub. Date: Aug. 25, 2011

(54) NEAR FIELD WIRELESS COMMUNICATION DEVICE

(75) Inventors: Takashi MINEMURA, Ome-shi (JP); Kengo KUROSE, Hamura-shi (JP)

(73) Assignee: KABUSHIKI KAISHA TOSHIBA, Tokyo (JP)

(21) Appl. No.: 13/033,497

(22) Filed: Feb. 23, 2011

(30) Foreign Application Priority Data
Feb. 23, 2010 (JP) 2010-037857
Dec. 24, 2010 (JP) 2010-288834

(51) Int. Cl. H04B 7/00

(52) U.S. Cl. 455/41.2

(57) ABSTRACT

According to one embodiment, a near field wireless communication device includes a receiver and a controller. The receiver is configured to obtain data by receiving a wireless signal. The controller is configured to stop the receiving operation of the receiver in the case where the receiver receives an unwanted signal.

### CROSS-REFERENCE TO RELATED APPLICATIONS

This application is based upon and claims the benefit of priority from Japanese Patent Applications No. 2010-037857, filed Feb. 23, 2010; and No. 2010-288834, filed Dec. 24, 2010; the entire contents of both of which are incorporated herein by reference.

### FIELD

Embodiments described herein relate generally to a near field or short-range wireless communication device which performs wireless communication by using an infrared ray, an electric wave, or the like, for example.

### BACKGROUND

As is well known, some of recent mobile phones have an infrared communication function in addition to a mobile communication function of performing wireless communication with a base station apparatus housed in a mobile communication network. The infrared communication function is a function of performing communication by sending/receiving an infrared signal to/from another mobile phone, for example. Currently, the infrared communication function is not an uncommon feature in digital cameras, personal digital assistants (PDAs), game machines, and the like.

In the case where the infrared communication function is adopted as an optional function in addition to the essential function, ON/OFF of the function is typically set by a user, and it is difficult for a user who is unused to the configuration to set to ON in the nick of time.

Therefore, some of the mobile phones are improved in user's handling easiness by setting the infrared communication function to ON as an initial state. However, when the infrared communication function is continuously in the ON state, there is a risk that an unwanted infrared communication is performed against the user's intention, and there has been a problem that there is a risk of consumption of battery power and hardware resource as well as leakage of information due to the unwanted infrared communication.

For instance, in the case where an unnecessary infrared communication signal is continuously sent from a malicious person, a receiving operation of a receiver of the infrared communication is continued to consume the battery power. Also, in the case where a malicious person makes a request for data communication including a process of questioning the user whether or not to perform the data communication before starting infrared data communication, and, for example, when the state of questioning is continued without being noticed by the user, there is a problem that necessary infrared communication cannot be performed in a state where the infrared communication is disabled.

The above-described problems are not limited to the infrared communication and can be observed in near field wireless communication such as a wireless LAN and Bluetooth (registered trademark).

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram illustrating one example of a mobile phone provided with a near field wireless communication function according to one embodiment;

FIG. 2 is a functional block diagram illustrating one example of a function of a main controller constituting a mobile phone according to the embodiment;

FIG. 3 is a flowchart illustrating one example of a near field wireless communication operation performed by the mobile phone according to the embodiment;

FIG. 4 is a flowchart illustrating one example of a near field wireless communication operation performed by the mobile phone according to the embodiment; and

FIG. 5 is a block diagram illustrating another example of a mobile phone provided with a near field wireless communication function according to the embodiment.

### DETAILED DESCRIPTION

Various embodiments will be described hereinafter with reference to the accompanying drawings. In general, according to one embodiment, a near field wireless communication device comprises a receiver and a controller. The receiver is configured to obtain data by receiving a wireless signal. The controller is configured to stop the receiving operation of the receiver in the case where the receiver receives an unwanted signal.

The near field wireless communication device according to the embodiment may be provided in a battery-powered electronic apparatus such as a mobile phone, a digital camera, a PDA, and a laptop personal computer (PC). In the following description, a near field wireless communication device to be mounted on a mobile phone will be exemplified.

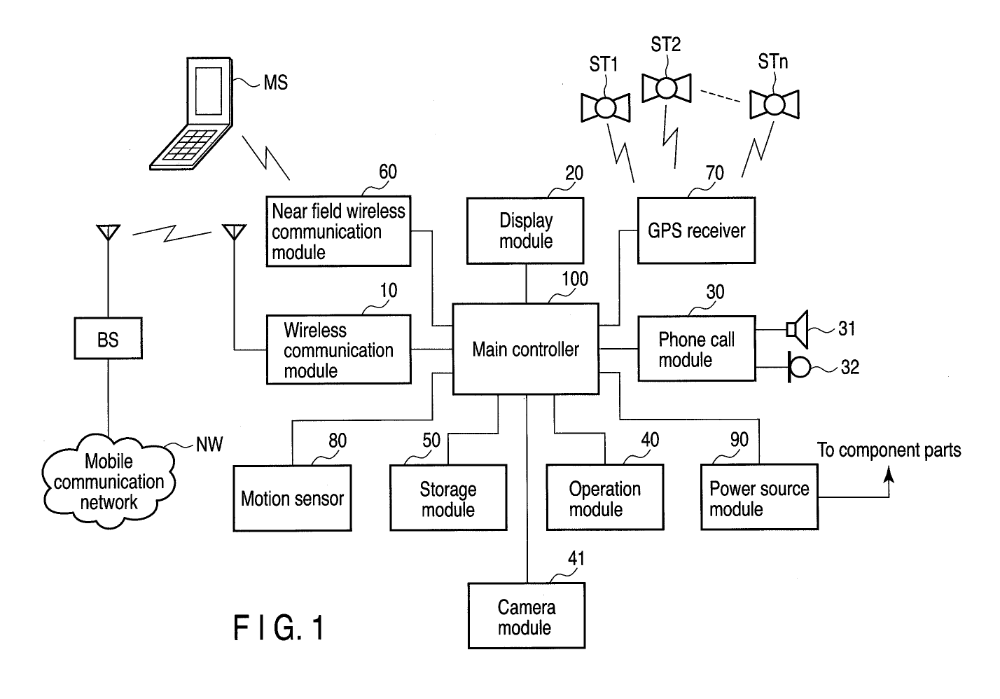

FIG. 1 shows a configuration of a mobile phone provided with a near field wireless communication function. The mobile phone comprises, as main constituent elements, a wireless communication module 10, a display module 20, a phone call module 30, an operation module 40, a camera module 41, a storage module 50, a near field wireless communications module 60, a global positioning system (GPS) receiver 70, a motion sensor 80, a power source module 90, and a main controller 100. As a call function, the mobile phone is provided with a mobile wireless communication function via a base station apparatus BS housed in a mobile communication network NW and the near field wireless communication function for performing wireless communication with another device having the near field wireless communication function.

The wireless communication module 10 performs wireless communication with the base station apparatus BS housed in the mobile communication network NW in response to an instruction from the main controller 100, thereby sending/receiving of voice data, e-mail data, or the like and receiving Web data, streaming data, or the like.

The display module 20 visually transmits information to a user by displaying an image (static image or dynamic image), text information or the like under the control of the main controller 100 and also displays information and the like indicating a setting state of the mobile phone.

The phone call module 30 comprises a speaker 31 and a microphone 32 and outputs a voice of the user input via the microphone 32 to the main controller 100 after converting the voice into voice data processable by the main controller 100 and outputs voice data, received by the wireless communication module 10 or the near field wireless communication module 60, from the speaker 31 after decoding the voice data.

The operation module 40 comprises a plurality of key switches and receives instructions from the user via the key switches.

The camera module 41 is a digital camera which electronically performs imaging by using an imaging element such as a complementary metal oxide semiconductor (CMOS) and a charge-coupled device (CCD) and stores in the storage module 50 described later image data obtained by the imaging and converted into compressed image data such as a joint photographic coding experts group (JPEG) under the control of the main controller 100.

The storage module 50 stores a control program and control data of the main controller 100, application software, address data in which names and telephone numbers of communication parties are associated with each other, e-mail data which have been sent and received, Web data which have been downloaded by Web browsing, and downloaded content data and temporarily stores streaming data or the like. The storage module 50 includes one or a plurality of storage units of an HDD, a RAM, a ROM, an IC memory, and the like.

The near field wireless communication module 60 performs wireless communication with another device (e.g. another mobile phone MS) having the near field wireless communication function by using an infrared ray, an electronic wave, or the like, and an operation setting is performed by the main controller 100. The near field communication module 60 sends send data given from the main controller 100 by the infrared ray or the electronic wave; receives data sent by the infrared ray or the electronic wave from the another device; and outputs the received data to the main controller 100 as received data.

The GPS receiver 70 receives GPS signals sent from GPS satellites ST1 to STn in response to an instruction from the main controller 100 to execute positioning calculation processing based on the plurality of received GPS signals and detects position information containing latitude, longitude, and altitude.

The motion sensor 80 comprises a tri-axial acceleration sensor, for example, and the like and detects a physical motion of the mobile phone in response to an instruction from the main controller 100. Thus, a direction and a speed of motion of the mobile phone are detected. The detection results are output to the main controller 100.

The power source module 90 supplies power accumulated in a battery (not shown) to the component parts of the mobile phone in response to instructions from the main controller 100.

The main controller 100 comprises a microprocessor and operates in accordance with the control program and the control data stored in the storage module 50 to control the component parts of the mobile phone in an integrated manner. The main controller 100 is provided with a mobile communication control function for controlling the component parts of a communication system for performing voice communication and data communication via the wireless communication module 10 as well as an application processing function.

The application processing function is realized when the main controller 100 operates in accordance with the application software stored in the storage module 50 and includes the near field wireless communication function for performing data communication with another device by controlling the near field wireless communication module 60, an e-mail function for sending/receiving an e-mail, a Web browsing function for browsing a Web page, and the like.

Also, the main controller 100 comprises an image processing function of displaying an image on the display module 20 based on received data and image data (data of static image and dynamic image) such as downloaded streaming data. With the image processing function, the main controller 100 displays an image on the display module 20 by decoding the image data and performing image processing on the decoded data.

The main controller 100 facilitates the near field wireless communication by causing the near field wireless communication module 60 to intermittently operate without an instruction from the user. The data sent and received by the near field wireless communication module 60 are not limited to the image data, and the near field communication module 60 is capable of sending and receiving data in various formats such as address data, various document files including text data, a data file in executable format, and the like.

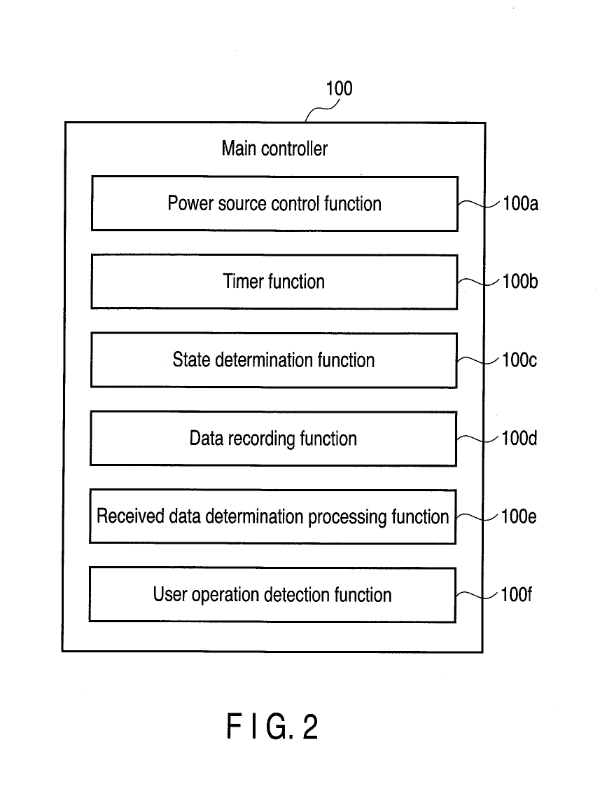

More specifically, as shown in FIG. 2, the main controller 100 is provided with, as a function for controlling the near field wireless communication module 60, a power source control function 100a for performing an ON/OFF control by controlling power supply to the near field wireless communication module 60, a timer function 100b for measuring an arbitrary elapsed time period, a state determination function 100c for detecting and determining a state of the mobile phone, a data recording function 100d for performing recording/deletion and the like of data obtained by the near field wireless communication, a received data determination processing function 100e for determining data received by the near field wireless communication, and a user operation detection function 100f for detecting an user operation via the operation module 40.

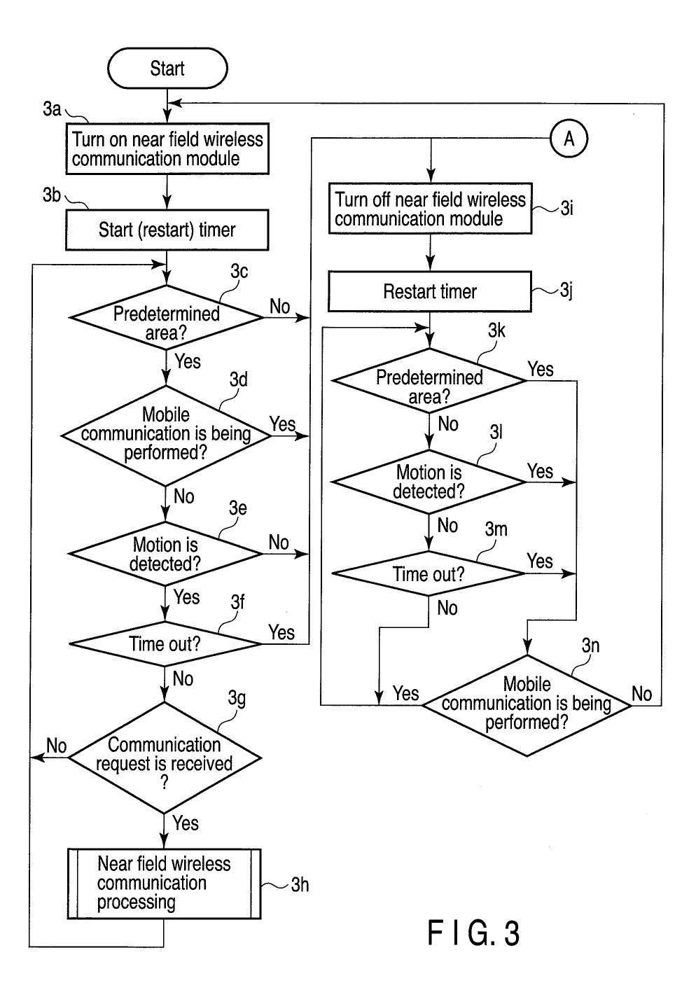

Hereinafter, an operation of the mobile phone having the above-described structure will be described. In the following description, an operation of wireless communication by using the near field wireless communication module 60 will particularly be described. A flowchart shown in FIG. 3 illustrates a control operation performed on the near field wireless communication module 60 by the main controller 100, and the control operation is repeatedly executed during at least a part of a period after turn-on of the power source of the mobile phone until the power source is turned off.

In Step 3a, the main controller 100 starts power supply to the near field communication module 60 by the power source control function 100a to activate the near field wireless communication module 60 and brings the near field wireless communication module 60 into a state of standby for receiving a signal by wireless communication using an infrared ray or an electric wave, thereby proceeding to Step 3b.

In Step 3b, the main controller 100 starts to count time by the timer function 100b (in the case where the timer function 100b has already been activated, restarts to count time from 0) and then proceeds to Step 3c. The counted time is equivalent to a time period for which the near field wireless communication module 60 has operated.

In Step 3c, the main controller 100 compares, using the state determination function 100c, the position information detected by the GPS receiver 70 with area information stored in the storage module 50 in response to an instruction from the user to determine whether or not a current position is within a range indicated by the area information. The main controller 100 proceeds to Step 3d in the case where the current position is within the range indicated by the area information or proceeds to Step 3i in the case where the current position is not within the range indicated by the area information. The area information indicates a range of coordinates (latitude, longitude, altitude) of the area which is arbitrarily registered by the user and is equivalent to an area for which the infrared communication is permitted (area out of an area for which the communication is not permitted).

In Step 3d, the main controller 100 determines whether or not mobile communication (voice communication or data communication) by the wireless communication module 10 is performed by using the state determination function 100c. The main controller 100 proceeds to Step 3i in the case where the mobile communication is performed or proceeds to Step 3e in the case where the mobile communication is not performed.

In Step 3e, the main controller 100 compares, the state determination function 100c, the detection result by the motion sensor 80 with a detection pattern which is preliminarily stored in the storage module 50 to determine whether the mobile phone is in a state of being carried by the user or held by the hand of the user. More specifically, it is determined whether or not the detection result of the motion sensor 80 is similar to the preliminarily set detection pattern within a predetermined level. The main controller 100 proceeds to Step 3f in the case where the detection result of the motion sensor 80 is motion similar to the preliminarily set pattern or proceeds to Step 3i in the case where the motion similar to the preliminarily set pattern is not detected.

In Step 3f, the main controller 100 determines whether or not the count time t by the timer function 100b which is started in Step 3b reaches a preliminarily set time T1 (time out). The main controller 100 proceeds to Step 3i in the case where the time T1 has elapsed (in the case where the near field wireless communication module 60 is in a reception standby state for a certain period of time or longer) or proceeds to Step 3g in the case where the time T1 has not elapsed.

In Step 3g, the main controller 100 determines whether or not the near field wireless communication module 60 has received from another near field wireless communication device a signal which requests wireless communication. The main controller 100 proceeds to Step 3h in the case where the signal requesting wireless communication has been received or proceeds to Step 3c in the case where the signal requesting wireless communication has not been received.

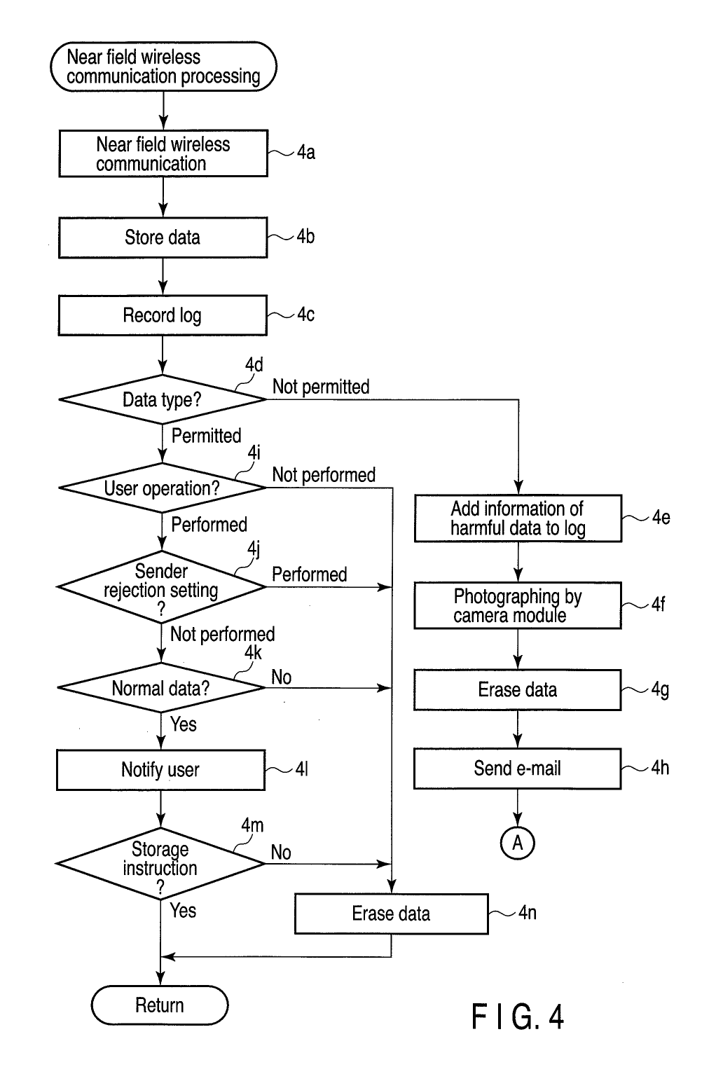

In Step 3h, the main controller 100 starts a near field wireless communication processing illustrated in FIG. 4. Details of the processing will be described later.

In Step 3i, the main controller 100 stops the power supply to, and the operation of, the near field wireless communication module 60 by using the power source control function 100a to cause a state of being incapable of standing by for receiving a signal by wireless communication and then proceeds to Step 3j.

In Step 3j, the main controller 100 restarts to count time by the timer function 100b from 0 to proceed to Step 3k. The counted time is equivalent to a time period for which the near field wireless communication module 60 has not been operated.

In Step 3k, the main controller 100 compares, using the state determination function 100c, the position information detected by the GPS receiver 70 with area information stored in the storage module 50 in response to an instruction from the user to determine whether or not a current position is within a range indicated by the area information. The main controller 100 proceeds to Step 3n in the case where the current position is within the range indicated by the area information or proceeds to Step 3l in the case where the current position is outside the range indicated by the area information. As in Step 3c, the area information indicates a range of coordinates (latitude, longitude, altitude) of the area which is arbitrarily registered by the user and is equivalent to an area for which the infrared communication is permitted (area out of an area for which the communication is not permitted).

In Step 3l, the main controller 100 compares, using the state determination function 100c, the detection result of the motion sensor 80 with a detection pattern which is preliminarily stored in the storage module 50 to determine whether the mobile phone is in a state of being carried by the user or held by the hand of the user. More specifically, it is determined whether or not the detection result of the motion sensor 80 is similar to the preliminarily set detection pattern within a predetermined level. The main controller 100 proceeds to Step 3n in the case where the detection result of the motion sensor 80 is motion similar to the preliminarily set pattern or proceeds to Step 3m in the case where the motion similar to the preliminarily set pattern is not detected.

In Step 3m, the main controller 100 determines whether or not the count time t by the timer function 100b which is started in Step 3j reaches a preliminarily set time T2 (time out). The main controller 100 proceeds to Step 3n in the case where the time T2 has elapsed (in the case where the near field wireless communication module 60 is in a stop state for a certain period of time or longer) or proceeds to Step 3k in the case where the time T2 has not elapsed.

In Step 3n, the main controller 100 determines whether or not mobile communication (voice communication or data communication) by the wireless communication module 10 is performed by using the state determination function 100c. The main controller 100 proceeds to Step 3k in the case where the mobile communication is performed or proceeds to Step 3a in the case where the mobile communication is not performed.

Hereinafter, the near field wireless communication processing in Step 3h will be described with reference to FIG. 4. In Step 4a, the main controller 100 controls the near field wireless communication module 60 to establish a communication link with another near field wireless communication device in accordance with a predetermined protocol and performs data communication to receive data from the near field wireless communication device, thereby proceeding to Step 4b.

In Step 4b, the main controller 100 stores the data received in Step 4a in the storage module 50 by using the data recoding function 100d and then proceeds to Step 4c.

In Step 4c, the main controller 100 stores a communication time period, identification information of a communication party, a size and a type of received data, a file name, and the like as a log in the storage module 50 by using the data recording function 100d and then proceeds to Step 4d.

In Step 4d, the main controller 100 detects the type of the data stored in Step 4b to determine whether or not reception of the type is permitted by using the received data determination processing function 100e. The main controller 100 proceeds to Step 4i in the case where the reception is permitted or proceeds to Step 4e in the case where the reception is not permitted. The type for which reception is permitted is preliminarily stored in the storage module 50. Also, as the determination, a virus check may be performed on the received data based on a pattern file of the virus which is preliminarily obtained.

In Step 4e, the main controller 100 adds a record indicating possibility of harmful data to the log recorded in Step 4c to store the log in the storage module 50 by using the data rerecording function 100d and then proceeds to Step 4f.

In Step 4f, the main controller 100 controls the camera module 41 to take a picture and records image data obtained by the photographing in the storage module 50, thereby proceeding to Step 4g. The thus-performed automatic photographing enables photographing of an ambient situation which can make it possible to take a picture of a person who sends the harmful data to the mobile phone.

In Step 4g, the main controller 100 detects, from the storage module 50, the data of the file name recorded in the log in Step 4c to erase (discard) the same, thereby proceeding to Step 4h.

In Step 4h, the main controller 100 controls the wireless communication module 10 to send an e-mail, indicating that the harmful data are received by the near field wireless communication, to a preliminarily set e-mail address, thereby proceeding to Step 3i. Thus, the above information is given to the user of the e-mail address.

In Step 4i, the main controller 100 determines whether or not a user operation has occurred during a preliminarily set period before reaching Step 4i and then proceeds to Step 4j in the case where the user operation has occurred or proceeds to Step 4n in the case where the user operation has not occurred. As the user operation, an operation on the operation module 40 is assumed. Also, in the case of a mobile phone capable of changing a shape of an appearance such as a slidable case or an open/close case, the user operation is determined based on a detection result of a switch for detecting the appearance shape change.

In Step 4j, the main controller 100 determines whether or not the identification information of the communication party recorded in the log in Step 4c is preliminarily recorded in the storage module 50 as a person from whom wireless signal reception is to be rejected. The main controller 100 proceeds to Step 4n in the case where the identification information is preliminarily recorded in the storage module 50 as the person from whom wireless signal reception is to be rejected or proceeds to Step 4k in the case where the record does not exist.

In Step 4k, the main controller 100 determines whether or not the data stored in the storage module 50 in Step 4b are perfectly normal data which are free from corruption, loss, and the like. The main controller 100 proceeds to Step 4l in the case where the data are the normal data or proceeds to Step 4n in the case where the data are not the normal data.

In Step 4l, the main controller 100 controls the display module 20 to perform a display for notifying that the data reception by wireless communication is normally finished and questioning whether or not the received data are allowed to be stored, thereby proceeding to Step 4m. Alternatively, other than the visual notification, a notification by a sound such as a voice or a melody may be adopted. Also, in the case of notifying receipt of a plurality of data, a list of information (file names) for identifying data is formed and displayed for the notification.

In Step 4m, the main controller 100 monitors a user operation on the operation module 40 to determine whether an operation for storing the received data is given by the user. The main controller 100 terminates the processing to proceed to Step 3c in the case where the storing operation is performed or proceeds to Step 4n in the case where the storing operation is not performed.

In Step 4n, the main controller 100 detects, from the storage module 50, the data of the file name stored in the log in Step 4c to erase (discard) the same and terminates the processing, thereby proceeding to Step 3c.

As described above, in the mobile phone having the above-described configuration, ON/OFF of the near field wireless communication module 60 is switched based on the detection of elapse of predetermined time period, the detection of staying area, the detection of motion, and the like even when there is not any particular user operation.

Therefore, according to the mobile phone of the above-described configuration, since the near field wireless communication module 60 is turned off under the predetermined conditions without any particular user operation, it is possible to prevent consumption of the battery and the hardware resource while facilitating the use of the near field wireless combination function by the user.

Also, even when data is received by the near field wireless communication, the received data are erased in the case where no user operation is detected for a predetermined time period or in accordance with the results of determining the sender's identification information, the data type, whether or not the data are normal, whether mobile communication is being performed, and the like. Therefore, in the case where a malicious sender sends unnecessary data to the user without being noticed by the user, it is possible to suppress a reduction in storage capacity of the storage module 50 by the unnecessary data.

As the unnecessary data which are sent by the malicious third party, a continuous wave, an interference wave out of a desired frequency, a meaningless data string, data intended for damaging system software, and the like are assumed.

Among the above data, as the continuous wave, an attack of continuously sending a CW signal is assumed, for example, by which a gap of time for other reception is eliminated and a power loss is caused due to the signal reception.

As the interference wave out of the desired frequency, intentional irradiation of the infrared ray receiving module with strong outside light or direct daylight is assumed. For the electric wave, a reduction in reception sensitivity of a receiver device which is caused by interference with a wireless transmitter pulse used at another frequency is assumed. For example, overlapping of a Wi-Fi beacon with an interference wave or the like is assumed.

Further, as the meaningless data string, resource consumption which is caused by forcing reception and data processing by sending the meaningless data string is assumed. The meaningless data string includes data which is not desired by the user such as a spam mail.

The data intended for damaging system software includes data such as a file in an executable file (.exe) format which causes system crash when executed.

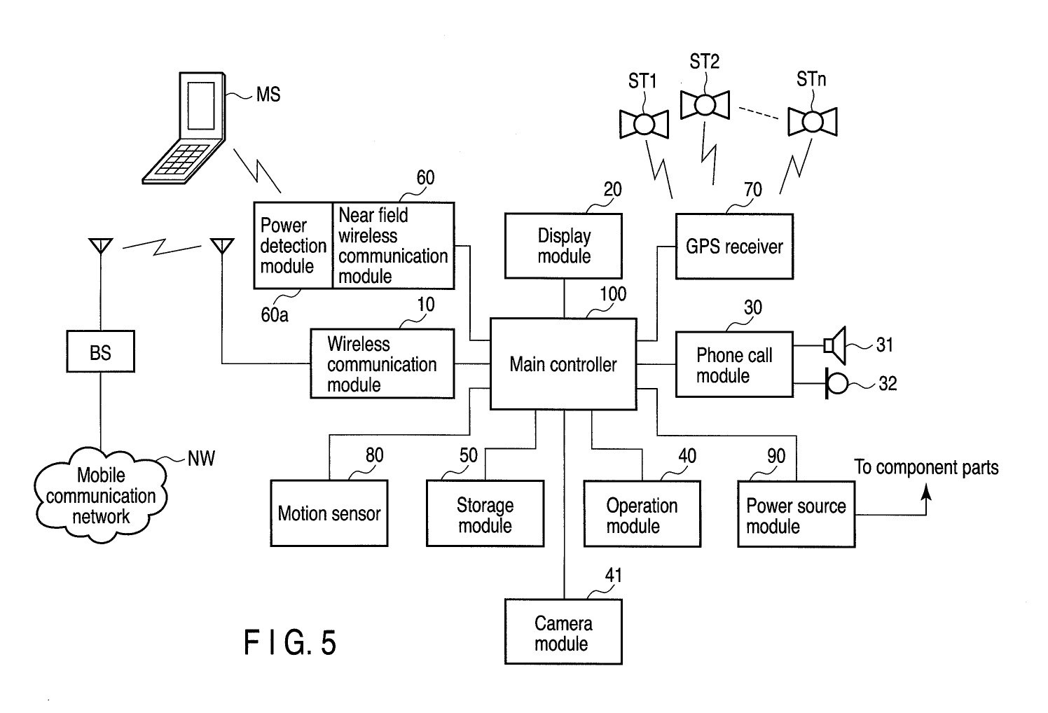

As to the continuous wave and the interference wave out of the desired frequency among the above, it is possible to determine whether or not each of the waves is incoming based on received power. In this case, it is possible to detect a change in power value with respect to a time axis by providing a power detection module 60a in the near field wireless communication module 60 as shown in FIG. 5.

Also, it is possible to detect each of the meaningless data string and the data intended for damaging system software based on the detection result of decoded data type by the received data determination processing function 100e of the main controller 100.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The various modules of the systems described herein can be implemented as software applications, hardware and/or software modules, or components on one or more computers, such as servers. While the various modules are illustrated separately, they may share some or all of the same underlying logic or code. The accompanying claims and their equivalents are intended to cover such forms or modifications as would fall within the scope and spirit of the inventions.

What is claimed is:

1. A short-ranged wireless communication device, the device comprising:
a receiver configured to receive data on a wireless signal; and
a controller configured to stop reception of the data by the receiver when a first signal is received by the receiver.

2. The short-range wireless communication device of claim 1, wherein
the controller is configured to determine whether the first signal, which is an unwanted signal, is received based on power of the received signal.

3. The short-range wireless communication device of claim 1, wherein
the controller is configured to determine whether the first signal, which is an unwanted signal, is received based on a result of decoding the received signal.

4. The short-range wireless communication device of claim 1, wherein
the controller comprises a type detection module configured to detect a type of the data and is configured to stop the data reception of the receiver when the type detected by the type detection module is a predetermined type.

5. The short-range wireless communication device of claim 1, further comprising:
an operation detection module configured to detect a user operation; and
an erasing module configured to erase the received data when the operation detection module fails to detect the user operation after a predetermined time period.

6. The short-range wireless communication device of claim 5, wherein
the short-range wireless communication device comprises a movable mechanism configured to change a shape of an outlook; and
the operation detection module is configured to detect the change of the shape of the outlook of the short-range wireless communication device as the user operation.

7. The short-range wireless communication device of claim 1, further comprising:
a sender detection module configured to detect a sender of the received data; and
an erasing module configured to erase the received data in accordance with the detected sender.

8. The short-range wireless communication device of claim 1, further comprising:
a type detection module configured to detect a type of the received data; and
an erasing module configured to erase the received data in accordance with the detected type.

9. The short-range wireless communication device of claim 1, further comprising:
a type detection module configured to detect a type of the received data; and
a history generation module configured to generate a communication history of the receiver comprising the detected type.

10. The short-range wireless communication device of claim 1, further comprising:
a storage module configured to store the received data; and
a notification module configured to notify a user that the received data are stored.

11. The short-range wireless communication device of claim 10, further comprising an input module,
wherein the notification module is configured to inquire the user whether the received data needs to be stored upon the data reception,
wherein the input module configured to receive an entry from the user, and
wherein the storage module is configured to store the received data in accordance with the entry from the user.

12. The short-range wireless communication device of claim 1, further comprising:
a wireless communication module configured to execute wireless communication with a base station in a mobile communication network, wherein
the controller is configured to stop the data reception of the receiver when the wireless communication is executed by the wireless communication module.

13. The short-range wireless communication device of claim 1, further comprising:
a motion detection module configured to detect a physical motion of the short-range wireless communication device, wherein
the controller is configured to stop the data reception of the receiver when the motion detection module fails to detect a predetermined motion.

14. The short-range wireless communication device of claim 1, further comprising:
a position detection module configured to detect position information of the short-range wireless communication device, wherein
the controller is configured to stop the data reception of the receiver when the position detection module fails to detect a predetermined position.
